(19) United States
(12) Patent Application Publication
(10) Pub. No.: US 2004/0138902 A1
(43) Pub. Date: Jul. 15, 2004

(54) Occupational safety system and method

(76) Inventors: Dennis M. Baca, Gainesville, VA (US); Michael J. Fanning, Silver Spring, MD (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/362,094

(22) PCT Filed: Sep. 6, 2001
(86) PCT No.: PCT/US01/27536

(30) Foreign Application Priority Data
Sep. 7, 2000 (US) 60230803

(51) Int. Cl. G06F 7/00

(52) U.S. Cl. 705/1

(57) ABSTRACT

The present invention provides a method and system for making occupational health and safety information available. Occupational health and safety information is provided via a computer system deployed at various locations, e.g., such that the health and safety information may be readily accessed in the event of a material spill, explosion, fire or other life-threatening occurrence. Similarly, any event which may have an adverse impact on the environment would also give rise to a need to access the computer system. In particular, a request for health and safety information is received (300), the system retrieves health and safety information (302). An urgency of the request is determined and selected health and safety information is provided based on the request and the urgency (304).

### REFERENCE TO RELATED APPLICATIONS

This application claims the benefit of priority under 35 U.S.C. § 119 from co-pending prior provisional application Serial No. 60/230,803, filed Sep. 7, 2000 for “OCCUPATIONAL SAFETY SYSTEM AND METHOD,” which is incorporated herein by reference.

### FIELD OF THE INVENTION

This invention relates to systems and methods for making occupational health and safety information available at the workplace.

### BACKGROUND OF THE INVENTION

The present day workplace has the potential to expose workers to many health and environmental risks, not only as a result of accidents, but also through normal exposure to hazardous substances. Largely as a result of Federal and state legislation, significant progress has been made to minimize the risk of exposure and to develop procedures to effectively deal with workplace mishaps, such as accidental spills, explosions, fires, and the like. Critical to this process is making available safety information to workers which discloses the nature of dangerous substances and provides appropriate procedures for containing spills and providing countermeasures to protect workers from exposure and treat personnel who have been exposed to minimize injury. Such information, until now, has been deployed in the form of material safety data sheets (MSDS), usually in paper-based form. When an incident occurs, the data sheets are consulted, much as one would look up an entry in a conventional dictionary. Obviously, when a hazardous event occurs, personnel are forced to make quick decisions based on consultation of such data, often in a cursory and frantic manner.

Therefore, it is desirable to provide a means for making safety-related data available in a manner which is expeditiously delivered and in a format which is readily comprehended.

### SUMMARY OF THE INVENTION

In accordance with the invention, a method for enhancing safety in the workplace comprises receiving a request for health and safety information; receiving an indication of an urgency for the request; and providing selected health and safety information based on the request and the urgency.

In accordance with another aspect of the invention, a system for enhancing safety in the workplace comprises: a database to store a plurality of health and safety information; a terminal to receive a request for health and safety information and receive an indication of an urgency for the request; and a server to search the database based on the request and provide the requested health and safety information based on the urgency.

In accordance with yet another aspect of the present invention, an apparatus for enhancing safety in the workplace comprises: means for receiving a request for health and safety information; means for receiving an indication of an urgency for the request; and means for providing selected health and safety information based on the request and the urgency.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIGS. 1a and 1b illustrate a format for a MSDS suggested by the Occupational Safety and Health Administration, which may be used in accordance with the principles of the present invention;

FIG. 2 illustrates a system consistent with the principles of the present invention; and

FIG. 3 illustrates a method consistent with the principles of the present invention.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

The present invention relates to an automated system and method for making health and safety information available to personnel in a comprehensive and rapid manner. For example, in the event of an incident, valuable time may be conserved and proper corrective action may be taken to prevent further injury and reduce any adverse environmental impact. Occupational health and safety information is provided via a computer system deployed at various locations, e.g., such that the health and safety information may be readily accessed in the event of a material spill, explosion, fire or other life-threatening occurrence. Similarly, any event which may have an adverse impact on the environment may also give rise to a need to access the computer system.

In one embodiment consistent with the present invention, a system provides health and safety information using material safety data sheets (“MSDS”) in computer-accessible format. For example, MSDS data may be stored in a computer database and called up by a user at a local or remote terminal. However, any type or format for providing health and safety information may be used in accordance with the principles of the present invention.

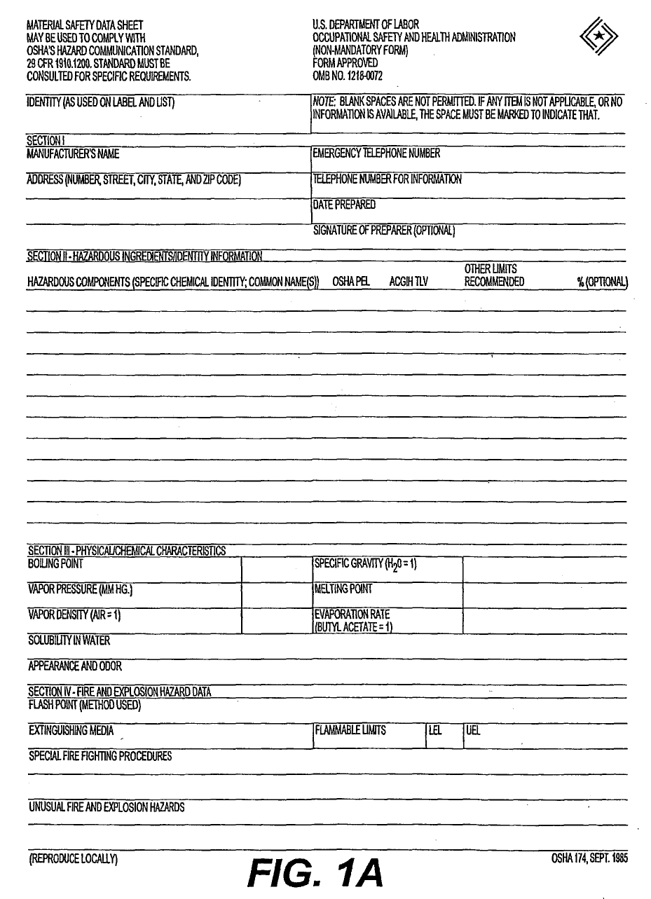

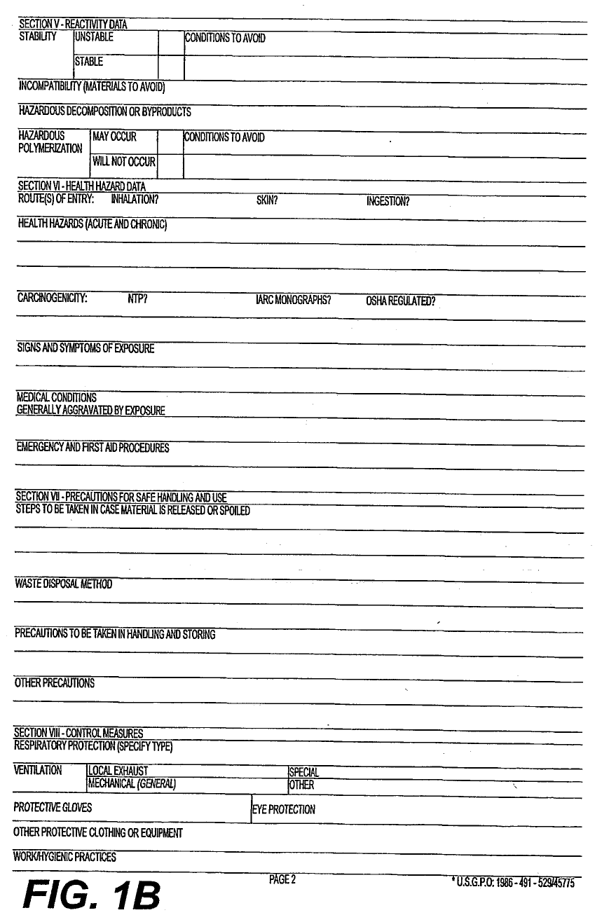

FIGS. 1a and 1b illustrate a format for a MSDS suggested by the Occupational Safety and Health Administration (“OSHA”), which may be used in accordance with the principles of the present invention. As shown, the MSDS suggested by OSHA may include sections I-VIII. Referring now to FIG. 1a, sections I-IV are shown. Section I provides for material identification. For example, section I may include: product name, a manufacturer's name and address; an emergency telephone number; a telephone number for identification; date the MSDS was prepared; and name of the preparer. Other information for material identification may also be included within section I.

Section II identifies hazardous ingredients and identity information. The hazardous ingredients and identity information included within section II may vary. However, all chemicals found to be hazardous should be included in section II. For example, OSHA has identified approximately 500 chemicals which are considered hazardous. In addition, all chemicals (even non-toxic chemicals) may also be listed in section II. Section II may include the following information: hazardous components; OSHA permissible exposure limit (PEL); American Conference of Govemmental Industrial Hygienists Threshold Limit Values (ACGIH TLV); other recommended limits; and percentage of concentration of chemical.

The hazardous component information may include a specific chemical identity or common name. For example, hazardous component information may be a chemical's trade name, a generic name, or chemical abstract service number. The OSHA PEL and ACGIH TLV provide information regarding exposure limits, i.e., the amount of exposure without any adverse effects, for each chemical. Other recommended limits may also be used to provide information from various organizations, such as the National Institute for Occupational Safety and Health. The percentage of concentration of each chemical may also be listed in section II.

Section III provides information regarding a material's physical and chemical characteristics. For example, section III may list information including: boiling point; vapor pressure; vapor density; appearance and odor; specific gravity; and evaporation rate.

Section IV provides information on the fire hazards and any special precautions to extinguish a fire or prevent an explosion. For example, section IV may include: flash point; flammable limits; lower explosive limit; upper explosive limit; extinguishing media, i.e., recommended fire extinguishing agents; special fire fighting procedures (if any); and unusual fire and explosion hazards.

Referring now to FIG. 1b, sections V-VIII of the MSDS are shown. Section V provides information describing reactivity of any chemicals in the material. The reactivity of a chemical may be a concern when mixing chemicals or storing various chemicals together. For example, section V may include: stability information, i.e., susceptibility of the material to decomposition; incompatibility, i.e., materials to avoid; hazardous decomposition products, i.e., hazardous materials produced from any chemical reactions; hazardous polymerization, i.e., the tendency of the material to produce molecules which combine in a violent reaction; and conditions or materials to avoid.

Section VI provides health hazard data to describe any health effects of the material, such as signs and symptoms of exposure and medical conditions made worse by exposure. For example, section VI may include: routes of entry information; acute health hazards; chronic health hazards; carcinogenicity of the material; signs and symptoms of exposure; medical conditions generally aggravated by exposure; and emergency and first aid procedures.

Section VII provides precautions for safe handling and use. For example, section VII may include: steps to be taken in case material is released or spilled; waste disposal method; precautions to be taken in handling and storing; and other precautions.

Section VIII provides control measure information that can reduce or eliminate a hazard caused by the material. For example, section VIII may include: respiratory protection recommended for use during routine or emergency situations; ventilation information to capture contaminants or prevent build-up of hazardous atmospheres; whether protective gloves are needed; whether other protective clothing or equipment is needed; and other work or hygienic practices recommended.

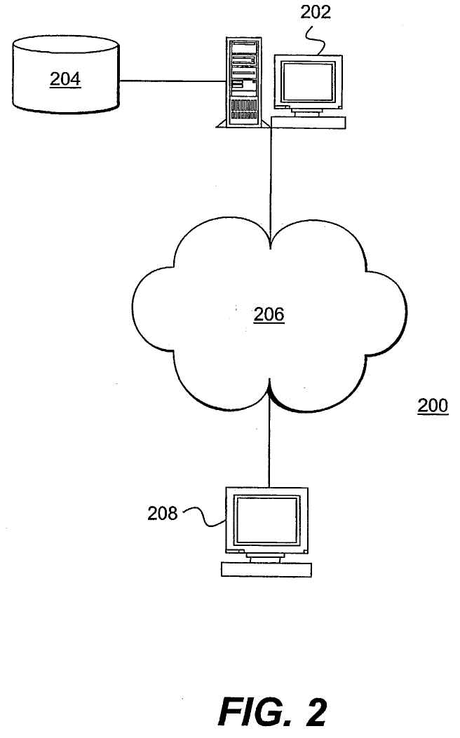

FIG. 2 illustrates a system 200 consistent with the principles of the present invention. In particular, system 200 may include a server 202, a database 204, a network 206, and a terminal 208. Server 202 maintains and provides health and safety information, such as MSDS. Server 202 may be implemented using any combination of known hardware and software. For example, server 202 may be implemented in a server computer using Microsoft Windows™, LINUX, UNIX, etc., as an operating system.

Server 202 maintains the health and safety information in database 204. Database 204 may be implemented using known technologies, such as Oracle™, DB2™, Microsoft Access™, structured query language (SQL), etc. Database 204 may be stored on memory within server 202. Alternatively, database 204 may be stored on a computer readable medium, such as a compact disk that is accessed by server 202. In addition, database 204 may be located remotely from server 202 and accessed across a network, e.g., network 206.

Network 206 may provide connectivity between server 202 and terminal 208. Network 206 may be implemented using any combination of network elements such as routers, switches, hubs, firewalls, etc. across a local area or a wide area. In addition, network 206 may be implemented as a public network, e.g., the Internet, or as a private network. Although FIG. 2 is shown with network 206, system 200 may be implemented with server 202 and terminal 208 integrated within a single machine or system without using an intervening network.

Terminal 208 provides an interface for a user to retrieve health and safety information. Terminal 208 may be implemented using any combination of hardware and software. For example, terminal 208 may be implemented as a personal computer including, e.g., a processor, a printer, a keyboard, a display, and a mouse. Alternatively, terminal 208 may be implemented using a “touch” screen to allow a user to enter search criteria and make selections by touching a screen directly.

In addition, terminal 208 may be configured to receive an indication of urgency for the health and safety information. For example, terminal 208 may receive an indication of urgency based upon user input. Terminal 208 may provide on screen “buttons” for: a normal search mode; and an emergency search mode. If the user selects the normal search mode button, terminal 208 may allow the user to enter any search criteria. However, if the user selects the emergency search mode button (indicating increased urgency), terminal 208 may configure the user interface to allow for accelerated searching of selected health and safety information, such as, emergency procedures in IV, VI, VII, or VIII of an MSDS. Terminal 208 may also provide a special “emergency” key, e.g., on a keyboard, which the user may depress to indicate an urgent situation.

Alternatively, terminal 208 may implicitly receive an indication of urgency based upon user behavior. For example, terminal 208 may receive an indication of an urgent situation if the user requests information regarding especially hazardous materials, e.g., explosive materials or requests information regarding emergency procedures, e.g., in sections IV, VI, VII, or VIII.

Terminal 208 may also receive an indication of urgency from one or more sources other than the user. For example, terminal 208 may receive signals from a fire alarm system. Terminal 208 may then provide the user accelerated access to fire and explosion information. However, any technique for receiving an indication of urgency for health and safety information is within the principles of the present invention.

Terminal 208 may include software such as a web browser to allow a user to request and navigate through various MSDS or sections of a particular MSDS. For example, terminal 208 may provide MSDS information using hypertext markup language (HTML) or extensible markup language (XML) via a web browser such as Microsoft Internet Explorer™ or Netscape Navigator™. Accordingly, a user at terminal 208 may use a succession of key entries, mouse clicks or finger contacts or gestures to navigate and request various MSDS or sections of a particular MSDS.

Terminal 208 may display virtually the same information as contained in hard copy versions of a MSDS, as illustrated in FIGS. 1a and 1b. The display of terminal 208 may also be fashioned so as to display the most relevant information in an attention-getting manner, such as by color coding, highlighting, dynamic effects (e.g., blinking), bold, underlining, or other techniques to make certain information appear prominent. In addition, terminal 208 may use a printer to provide hard copy versions of a MSDS. However, terminal 208 may use any method to provide health and safety information such as facsimile, email, etc. in accordance with the principles of the present information.

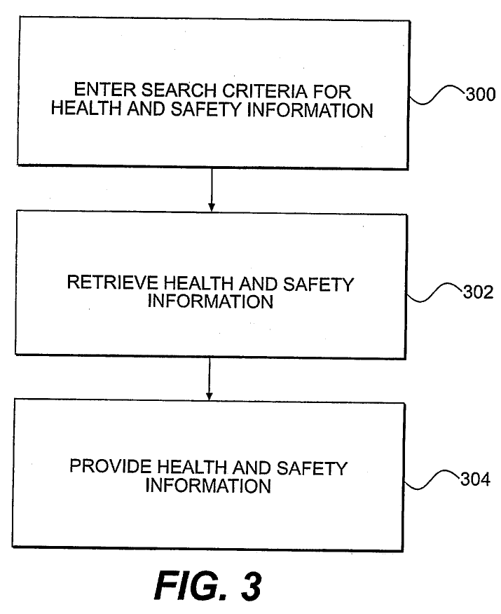

FIG. 3 illustrates a method consistent with the principles of the present invention. In step 300, a user at terminal 208 enters search criteria for health and safety information. Terminal 208 may also receive an indication of urgency associated with the entered search criteria. As described above, terminal 208 may receive the indication of urgency based upon user input or from a source other than the user. For example, terminal 208 may provide a normal search mode and an emergency search mode based upon the indication of urgency. Under a normal search mode, terminal 208 may allow the user to enter any search criteria. However, under an emergency search mode, terminal 208 may configure the user interface to allow for accelerated searching of selected health and safety information. For example, terminal 208 may provide the user accelerated retrieval of: section IV information, i.e., fire and explosion information; section VI information, i.e., health hazard information; section VII, i.e., spill or leak procedures; or section VIII information, i.e., control measure information. Accordingly, under emergency mode, a user with an emergency response team may provide terminal 208 an indication of urgency to, e.g., quickly retrieve critical information, respond more appropriately, reduce or prevent injury, and reduce or prevent environmental impact.

As noted above, the user may enter the search criteria at terminal 208 using, e.g., a keyboard, a mouse, or touching a screen via a web browser. The search criteria may be entered using a wide variety of techniques including: boolean operators; natural language; or a series of menus. The search criteria may be based on any information stored within database 206. For example, the search criteria may include any information provided in sections I-VIII in an MSDS as described above with reference to FIGS. 1a and 1b. Upon terminal 208 receiving the search criteria and the indication of urgency, processing then flows to step 302.

In step 302, terminal 208 provides server 202 the search criteria entered by the user and the indication of urgency. Server 202 then retrieves the relevant health and safety information based upon the search criteria and indication of urgency. For example, server 202 may receive the search criteria and indication of urgency within an HTML or XML request from terminal 208. Server 202 may then use one or more SQL requests to database 206 to retrieve the relevant health and safety information. Upon retrieving the requested health and safety information, processing then flows to step 304.

In step 304, server 202 may provide the relevant health and safety information to terminal 208 within an HTML or XML response. Terminal 208 may then provide the relevant health and safety information to the user. For example, terminal 208 may use a display or printer to provide the information. In addition, terminal 208 may use techniques to make certain information more prominent, e.g., based upon the indication of urgency. As noted above, these techniques may include: color coding; highlighting; dynamic effects; bold; underlining, etc.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for enhancing safety in the workplace, comprising:
receiving a request for health and safety information;
receiving an indication of an urgency for the request; and
providing selected health and safety information based on the request and the urgency.

2. The method of claim 1, further comprising:
determining a portion of the health and safety information based on the urgency; and
providing the portion in a prominent manner.

3. The method of claim 1, wherein receiving a request for health and safety information comprises:
receiving material safety data sheet information.

4. A system for enhancing safety in the workplace, comprising:
a database to store a plurality of health and safety information;
a terminal to receive a request for health and safety information and an indication of an urgency for the request; and
a server to search the database based on the request and provide the requested health and safety information based on the urgency.

5. The system of claim 4, wherein the database comprises a plurality of information for material safety data sheets.

6. The system of claim 4, wherein the terminal comprises:
a web browser to receive the request;
a processor to send the request to the server; and
an output to provide the requested health and safety information.

7. An apparatus for enhancing safety in the workplace, comprising:
means for receiving a request for health and safety information;
means for receiving an indication of an urgency for the request; and
means for providing selected health and safety information based on the request and the urgency.

8. A computer readable medium for configuring a computer to perform a method for enhancing safety in the workplace, the method comprising:
receiving a request for health and safety information;
receiving an indication of an urgency for the request; and
providing selected health and safety information based on the request and the urgency.
